(19) United States
(12) Patent Application Publication
(10) Pub. No.: US 2015/0158044 A1
(43) Pub. Date: Jun. 11, 2015

(54) AUTOMATED MASKING OF COOLING APERTURES

(71) Applicant: General Electric Company, Schenectady, NY (US)

(72) Inventors: Thomas Robert Reid, Greenville, SC (US); Cem Murat Eminoglu, Simpsonville, SC (US); Jonathan Matthew Lomas, Simpsonville, SC (US)

(73) Assignee: General Electric Company, Schenectady, NY (US)

(21) Appl. No.: 14/098,777

(22) Filed: Dec. 6, 2013

(51) Int. Cl. B05B 12/12; B05D 1/02; B05B 12/02

(52) U.S. Cl. CPC B05B 12/12; B05B 12/02; B05D 1/02

(57) ABSTRACT

A system including: a masking applicator; and at least one computing device coupled with the masking applicator, the at least one computing device configured to provide instructions to the masking applicator to apply a masking material according to a masking plan for masking at least one cooling aperture in a turbomachine component during a cooling aperture coating process, the masking plan based upon at least one characteristic of the plurality of cooling apertures, the masking plan including masking the at least one cooling aperture using a first mask type.

### FIELD OF THE INVENTION

The subject matter disclosed herein relates to fabrication of materials in turbomachinery. More particularly, the subject matter disclosed herein relates to masking of apertures in turbomachinery.

### BACKGROUND OF THE INVENTION

A challenge in turbomachinery (e.g., gas turbomachines) repair is the clearing and restoration of cooling holes after a part has had its coating stripped and recoated. This challenge is not faced in original part manufacturing, as the cooling holes are fabricated after the part has been coated. This challenge can be amplified by the fact that advanced turbomachine component designs may have in the magnitude of several hundred of these cooling passages. Restoring the holes to the original geometry and removing all coating and masking debris from the cooling passages can be critical to the quality of the repair.

### BRIEF DESCRIPTION OF THE INVENTION

Various embodiments of the invention include approaches for masking cooling apertures in turbomachine components according to characteristics of those cooling apertures. In various embodiments, a system includes: a masking applicator; and at least one computing device coupled with the masking applicator, the at least one computing device configured to provide instructions to the masking applicator to apply a masking material according to a masking plan for masking at least one cooling aperture in a turbomachine component during a cooling aperture coating process, the masking plan based upon at least one characteristic of the at least one cooling aperture, the masking plan including masking of the at least one cooling aperture using a first mask type.

A first aspect of the invention includes a system having: a masking applicator; and at least one computing device coupled with the masking applicator, the at least one computing device configured to provide instructions to the masking applicator to apply a masking material according to a masking plan for masking at least one cooling aperture in a turbomachine component during a cooling aperture coating process, the masking plan based upon at least one characteristic of the at least one cooling aperture, the masking plan including masking the at least one cooling aperture using a first mask type.

A second aspect of the invention includes a method including: removing a previously applied coating from a turbomachine component; obtaining data about at least one characteristic of at least one cooling aperture in the turbomachine component; determining a masking plan for masking the at least one cooling aperture in the turbomachine component during a cooling aperture coating process based upon the at least one characteristic of the cooling aperture, the masking plan including masking the at least one cooling aperture using a first mask type; applying a masking material to the turbomachine component according to the masking plan, after the removing of the previously applied coating; and applying a coating material to the turbomachine component after the applying of the masking material.

A third aspect of the invention includes a computer program product comprising program code embodied in a computer readable storage medium, which when executed by at least one computing device, causes the at least one computing device to perform actions including: obtaining data about at least one characteristic of at least one cooling aperture in a turbomachine component; determining a masking plan for masking the at least one cooling aperture in the turbomachine component during a cooling aperture coating process based upon the at least one characteristic of the at least one cooling aperture, the masking plan including masking the at least one cooling aperture using a first mask type; and providing instructions to a masking applicator to apply a masking material to the turbomachine component according to the masking plan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative environment including a turbomachine component and a selective masking system according to various embodiments of the invention.

FIG. 2 shows a flow diagram illustrating a method performed according to various embodiments of the invention.

FIG. 3 shows example masks for masking apertures in a turbomachine component according to various embodiments of the invention.

FIG. 4 shows a flow diagram illustrating a method performed according to various embodiments of the invention.

FIG. 5 shows a schematic depiction of a masking plan according to various embodiments of the invention.

FIG. 6 shows a schematic depiction of an additional masking plan according to various embodiments of the invention.

FIG. 7 shows a schematic depiction of another masking plan according to various embodiments of the invention.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the subject matter disclosed herein relates to fabrication of materials in turbomachinery. More particularly, the subject matter disclosed herein relates to masking of apertures in turbomachinery, prior to coating of the turbomachinery.

As noted herein, one challenge in turbomachinery (e.g., gas and/or steam turbomachines) repair is the clearing and restoration of cooling apertures (holes) after a part has had its coating stripped and is going through the process of being recoated. This challenge is not faced in original part manufacturing, as the cooling holes are fabricated after the part has been coated. This challenge can be amplified by the fact that advanced turbomachine component designs may have in the magnitude of several hundred of these cooling passages. Restoring the holes to the original geometry and removing all coating and masking debris from the cooling passages can be a significant contributor to the quality of the repair.

Various embodiments of the invention include automated processes for tailored masking of cooling apertures based upon data about those cooling apertures (e.g., type of aperture, size, location, etc.). In various embodiments, approaches include: a) obtaining data about the one or more cooling apertures in a turbomachine component, b) determining a mask strategy for masking the one or more cooling apertures, and c) applying a mask to the turbomachine component (proximate the one or more cooling apertures) to execute the mask strategy.

In contrast to conventional approaches, the mask strategy includes a mask that varies by aperture (or by groups of apertures) to specifically tailor the mask to the type of apertures present in the turbomachine component. In various embodiments, a first sub-set of apertures in the group of apertures are masked in a first manner, and a second sub-set of apertures in the group of apertures are masked in a second, distinct manner, based upon the data about the apertures (e.g., type of aperture, size, location, shape, etc.).

Various particular aspects include a system having: a masking applicator; and at least one computing device coupled with the masking applicator, the at least one computing device configured provide instructions to the masking applicator to apply a masking material according to a masking plan for masking one or more cooling apertures in the turbomachine component during a cooling aperture coating process, the masking plan based upon at least one characteristic of the cooling aperture(s), the masking plan including masking a first set of cooling apertures in the one or more cooling apertures using a first mask type (optionally, masking a second, distinct set of cooling apertures in the plurality of cooling apertures using a second, distinct mask type).

Additional particular aspects include a method including: removing a previously applied coating from a turbomachine component; applying a masking material to the turbomachine component after the removing of the previously applied coating; applying a coating material to the turbomachine component after the applying of the masking material; obtaining data about at least one characteristic of at least one cooling aperture in the turbomachine component; determining a masking plan for masking the at least one cooling aperture in the turbomachine component during a cooling aperture coating process based upon the at least one characteristic of the at least one cooling aperture, the masking plan including masking of the at least one cooling aperture using a first mask type; applying the masking material to the turbomachine component according to the masking plan; and applying a coating to the turbomachine component after the applying of the masking material according to the masking plan

Other particular aspects include a system having: a stripping system for removing a previously applied coating from a turbomachine component; a masking applicator for applying a masking material to the turbomachine component after the removing of the previously applied coating; a coating applicator for applying a coating to the turbomachine component after the masking; and at least one computing device coupled with the masking applicator and the coating applicator, the at least one computing device configured to: obtain data about at least one characteristic of one or more cooling apertures in the turbomachine component; determine a masking plan for masking the one or more cooling apertures in the turbomachine component during a cooling aperture coating process based upon the at least one characteristic of the one or more cooling apertures, the masking plan including masking a first set of cooling apertures in the one or more cooling apertures using a first mask type (and optionally, masking a second, distinct set of cooling apertures in the plurality of cooling apertures using a second, distinct mask type); provide instructions to the masking applicator to apply the masking material to the turbomachine component according to the masking plan; and provide instructions to the coating applicator to apply a coating to the turbomachine component after applying the masking material according to the masking plan.

Additional particular aspects include a computer program product comprising program code embodied in a computer readable storage medium, which when executed by at least one computing device, causes the at least one computing device to perform actions including: obtaining data about at least one characteristic of one or more cooling apertures in a turbomachine component; determining a masking plan for masking the one or more cooling apertures in the turbomachine component during a cooling aperture coating process based upon the at least one characteristic of the one or more cooling apertures, the masking plan including masking a first set of cooling apertures in the one or more cooling apertures using a first mask type (and optionally, masking a second, distinct set of cooling apertures in the plurality of cooling apertures using a second, distinct mask type); and providing instructions to a masking applicator to apply a masking material to the turbomachine component according to the masking plan.

In the following description, reference is made to the accompanying drawings that form a part thereof, and in which is shown by way of illustration specific example embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely illustrative.

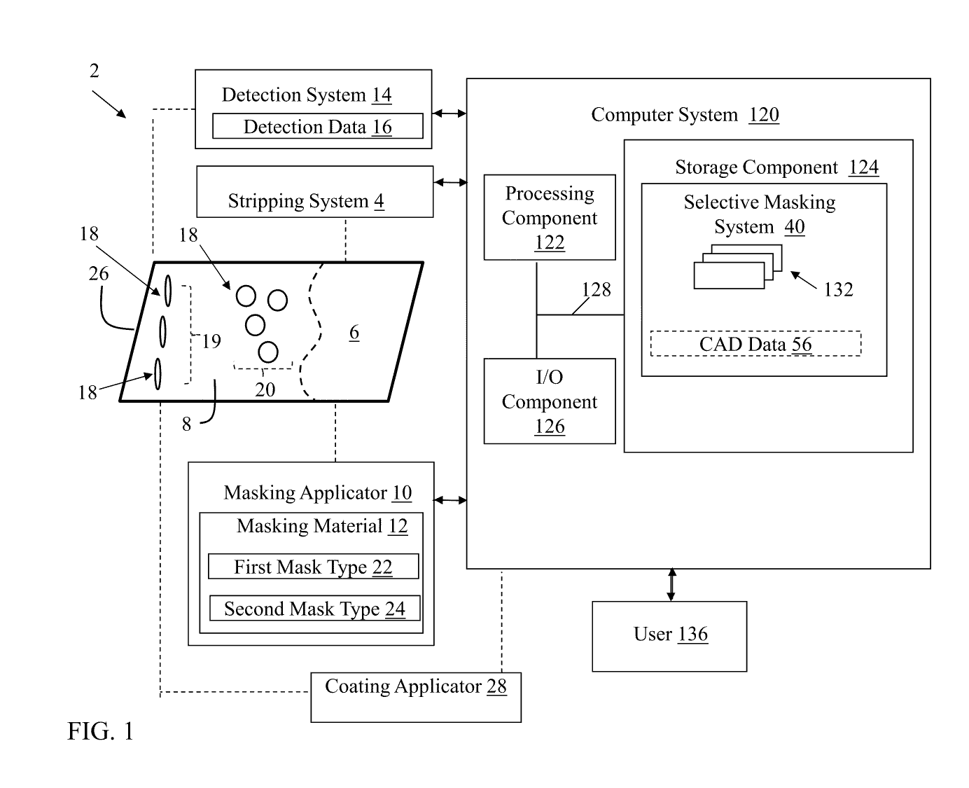

FIG. 1 shows a schematic depiction of a system 2 according to various embodiments of the invention. As shown, the system 2 can include a stripping system 4 for removing a previously applied coating 6 from a turbomachine component 8. Also shown, the system 2 can include a masking applicator 10 for applying a masking material 12 to the turbomachine component 8 after the removing of the previously applied coating 6 (shown partially removed from the turbomachine component 8. In various embodiments, the masking applicator 10 includes a localized deposition apparatus, e.g., at least one of a robot applicator, an aerosol printer or an ink-jet printer. It is understood that according to various embodiments, one or more systems, components, etc. shown and described herein may be part of separate systems, and need not be coupled as illustrated or described herein. For example, in some embodiments, the stripping system 4 may be a separated (e.g., physically separated) from the masking applicator 10, or other components shown or described herein.

In some cases, the system 2 can further include a detection system 14 (e.g., a vision system such as a camera, laser-based optical system, etc.); a tactile detection system; a photogrammetry system; an electromagnetic location detection system; a thermal detection system; and/or an infrared detection system) configured to obtain detection data 16 about the turbomachine component 8 by imaging at least one portion of the turbomachine component 8. As is known in the art, the turbomachine component 8 can include cooling apertures 18 for allowing the flow of cooling fluid therethrough, e.g., during operation of a turbomachine employing the component 8. The turbomachine component 8 can include at least one of a turbomachine blade, nozzle, bucket, shroud, flange, and/or a combustion hardware component such as a liner, a can, a transition piece, a cover plate, etc.

The system 2 can further include at least one computing device (computer system 120 including tailored masking system 40) coupled with the masking applicator 10 (and in some cases, the stripping system 4, coating applicator 28 and/or detection system 14). The at least one computing device (computer system 120, including tailored masking system 40, and referred to herein as “tailored masking system 40) is configured to perform actions (in conjunction with one or more of the stripping system 4, masking applicator 10 or detection system 14 and/or coating applicator 28) to mask cooling apertures 18 in the turbomachine component 8.

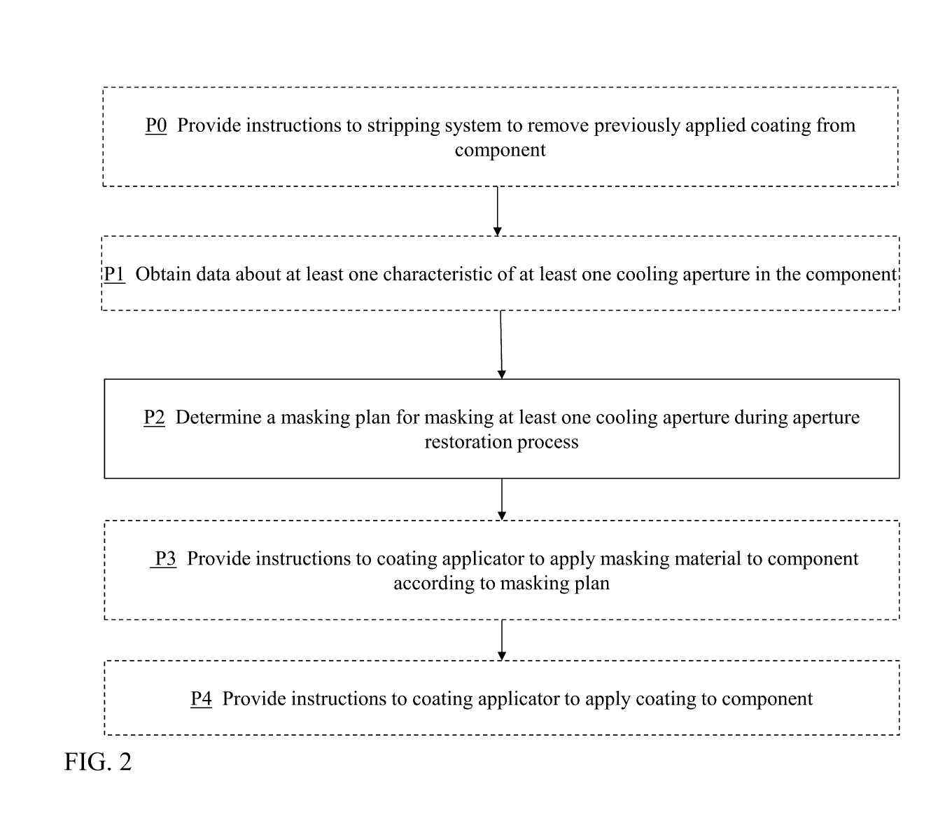

FIG. 2 shows a flow chart illustrating processes performed by the at least one computing device (tailored masking system 40) to tailor masking of cooling aperture(s) 18 in the turbomachine component 8 based upon characteristics of the cooling aperture(s) 18. With continuing reference to FIG. 1, the process(es) can include:

Optional preliminary process P0 (shown in phantom): provide instructions to the stripping system 4 to remove the previously applied coating 6 from the turbomachine component (or simply, component) 8. This process can include using a conventional stripping technique such as fluid jet stripping, laser stripping, and/or grit-blast stripping.

Process P1: obtain data about at least one characteristic of at least one cooling aperture 18 (e.g., one or more apertures 18) in the component 8. In some cases, as described herein, the data can be obtained as detection data 16 from the detection system 14. In other cases, the data about the characteristic can include computer-aided design (CAD) data 56 such as coordinate data, log data, model data (e.g., two-dimensional and/or three-dimensional model data), that the tailored masking system 40 obtains from a data model (stored in CAD data 56) of the component 8. In various embodiments, the characteristic of the cooling apertures 18 in the component 8 can include at least one of a size of each of the plurality of cooling apertures, a shape of each of the plurality of cooling apertures, a type of each of the plurality of cooling apertures or a location of each of the plurality of cooling apertures. In various embodiments, the CAD data 56 can include data about the size and/or shape of aperture(s) 18 in the component 8, while the detection data 16 can include data about the location(s) of aperture(s) 18 in the component 8.

Process P2: determine a masking plan for masking the cooling aperture(s) 18 in the component 8 during a cooling aperture coating process. The masking plan can be determined based upon the at least one characteristic of the cooling aperture(s) 18. In some cases, the masking plan can include masking at least one cooling aperture 19 (e.g., in the plurality of cooling apertures 18) using a first mask type 22. In various embodiments, the masking plan can also include masking a second, distinct set of cooling aperture(s) 20 (e.g., in the plurality of cooling apertures 18) using a second, distinct mask type 24. The distinct mask types 22, 24, will provide distinct masking of the cooling apertures 18 during a subsequent coating process. It is understood that the masking types 22, 24 described herein can differ in terms of their size, shape, pattern and/or application. In various embodiments, the first mask type 22 and the second mask type 24 can include substantially identical material compositions, however, can be applied in distinct shapes, sizes, patterns and/or application techniques. In various embodiments, the first set of cooling apertures 19 include film cooling apertures (e.g., cooling apertures with oval-shaped cross-sections), and the second set of cooling apertures 20 include rounded cooling apertures (with substantially circular cross-sections). In various embodiments, the second set of cooling apertures 20 (rounded cooling apertures) are located downstream in a fluid flow path from a the first set of cooling apertures 19.

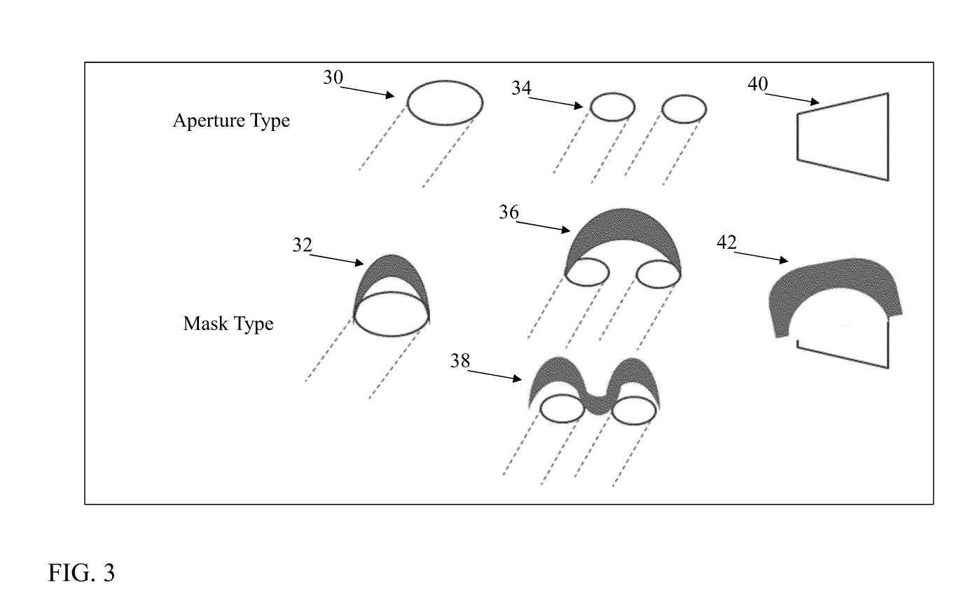

Process P3: provide instructions to the masking applicator 10 to apply the masking material 12 to the component 8 according to the masking plan. In this process, the masking applicator 10 applies a masking material 12, e.g., a silicon based material, graphite, aluminum oxide, silicone putty, etc. to the component 8 proximate the cooling apertures 18 according to the masking plan. In various embodiments, the masking material 12 can include ultra-violet (UV) curable materials. FIG. 3 illustrates several example masking variations for distinct aperture types. For example, for the large oval aperture 30, a large arched mask 32 can be applied to mask the aperture 30. For a pair of smaller oval apertures 34, either a single extended arched mask 36 can be used to mask the pair of smaller oval apertures 34, or a sinusoidal mask 38 can be used to mask each of the smaller oval apertures 34 and extend between the two smaller oval apertures 34. For a trapezoid-shaped aperture 40, a distended arch mask 42 can be used to mask the aperture. It is understood that as described herein the masking material 12 can be applied to at least partially fill one or more apertures 18 in order to effectively mask the aperture(s) 18 during subsequent coating. That is, the masking material 12 can be applied to compliment the shape of the aperture(s) 18, according to the type of aperture 18 being masked. As described herein, this tailored approach allows for masking of apertures 18 based upon determined characteristics of the aperture(s) 18, increasing the effectiveness of the masking process when compared with conventional approaches.

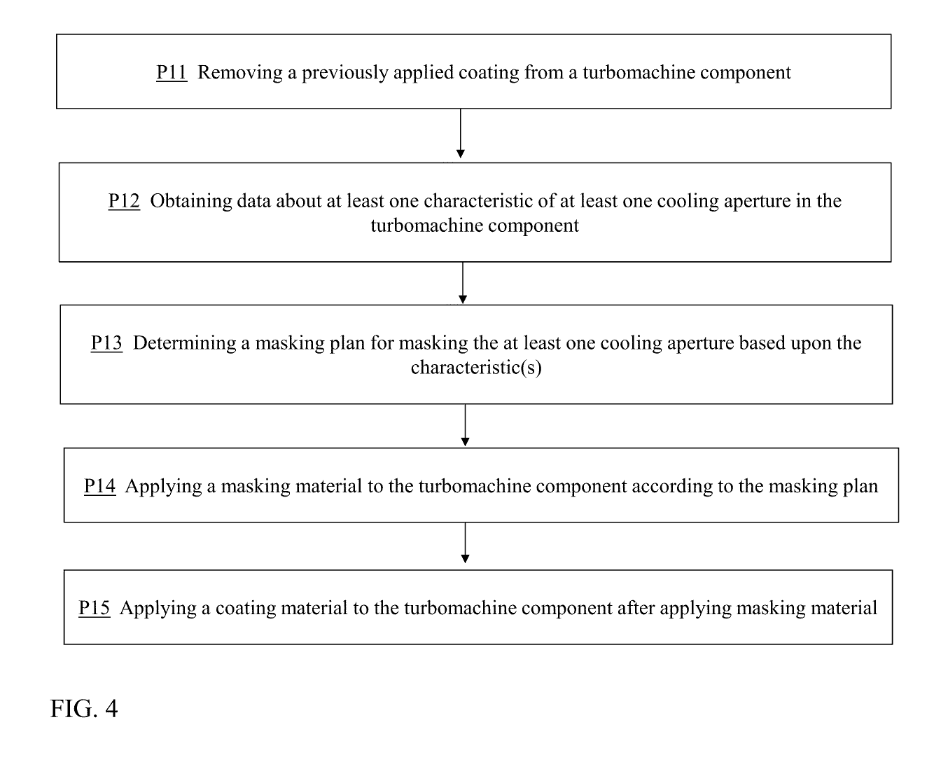

Returning to FIGS. 1-2, optional post-process P4 can include: providing instructions to the coating applicator 28 to apply a metallic bondcoat, and (subsequently) a coating (e.g., thermal barrier coating (TBC)) to the component 8 after applying the masking material 12 according to the masking plan. In the case that the coating includes a TBC coating, the TBC can be blanket applied in some cases, and the masking material 12 can prevent the TBC from filling the cooling apertures 18 and obstructing those apertures 18 during use of the component 8. It is understood, however, that the coating process may have several sub-processes. For example, the first coating process can include a bond coat, applied through air-plasma spray (APS) process or a high-velocity-oxygen-fuel (HVOF) process, or a combination of these processes. The following coating may include the TBC, applied using an APS process. According to various embodiments, the masking material 12 used in each process can be distinct. For example, bond coat is a lower-temperature process that employs high-velocity particles (similar to grit blasting). TBC, on the other hand, is a relatively higher-temperature process. Using TBC may require a multiple layer and material composition masking process. It is understood that according to various embodiments, other coating processes may be employed, e.g., environmental barrier coating (EBC), in the case that the component 8 includes a composite. In various embodiments, additional coating materials may be used, in the first coating process and/or the second coating process. For example, additional coating materials can include ceramic materials and/or ceramic-similar materials, such as aluminum-oxide, zirconium-oxide, hafnium-oxide, Yttria-stabilized zirconium-oxide and/or their derivatives. Additionally, coating materials can include graphite, as well as metallic materials such as cobalt-chromium-molybdenum. It is understood that according to various embodiments, prior the process of coating, an additional process can include grit blasting the exposed surfaces of the component 8 to achieve a desired surface roughness. It is also understood that according to various embodiments, an additional process can include curing the masking material (e.g., via ultra-violet exposure or application of heat) prior to the coating. These processes may be interposed between, or performed before/after processes described with reference to FIG. 2 and/or FIG. 4.

Returning to FIG. 1, computer system 120 is shown including a processing component 122 (e.g., one or more processors), a storage component 124 (e.g., a storage hierarchy), an input/output (I/O) component 126 (e.g., one or more I/O interfaces and/or devices), and a communications pathway 128. In one embodiment, processing component 122 executes program code, such as tailored masking system 40, which is at least partially embodied in storage component 124. While executing program code, processing component 122 can process data, which can result in reading and/or writing the data to/from storage component 124 and/or I/O component 126 for further processing. Pathway 128 provides a communications link between each of the components in computer system 120. I/O component 126 can comprise one or more human I/O devices or storage devices, which enable a user 136 (e.g., human or machine user) to interact with computer system 120 and/or one or more communications devices to enable user 136 (e.g., human or machine user) to communicate with computer system 120 using any type of communications link. To this extent, tailored masking system 40 can manage a set of interfaces (e.g., graphical user interface(s), application program interface, and/or the like) that enable human and/or system interaction with tailored masking system 40.

In any event, computer system 120 can comprise one or more general purpose computing articles of manufacture (e.g., computing devices) capable of executing program code installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, tailored masking system 40 can be embodied as any combination of system software and/or application software. In any event, the technical effect of computer system 120 is to apply a masking material 12 to a turbomachine component 8 in a tailored manner.

Further, tailored masking system 40 can be implemented using a set of modules 132. In this case, a module 132 can enable computer system 20 to perform a set of tasks used by tailored masking system 40, and can be separately developed and/or implemented apart from other portions of tailored masking system 40. Tailored masking system 40 may include modules 132 which comprise a specific use machine/hardware and/or software. Regardless, it is understood that two or more modules, and/or systems may share some/all of their respective hardware and/or software. Further, it is understood that some of the functionality discussed herein may not be implemented or additional functionality may be included as part of computer system 120.

When computer system 120 comprises multiple computing devices, each computing device may have only a portion of tailored masking system 40 embodied thereon (e.g., one or more modules 132). However, it is understood that computer system 120 and tailored masking system 40 are only representative of various possible equivalent computer systems that may perform a process described herein. To this extent, in other embodiments, the functionality provided by computer system 120 and tailored masking system 40 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 120 includes multiple computing devices, the computing devices can communicate over any type of communications link. Further, while performing a process described herein, computer system 120 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, tailored masking system 40 enables computer system 120 to control tailored masking of a turbomachine component 8. Tailored masking system 40 may include logic for performing one or more actions described herein. In one embodiment, tailored masking system 40 may include logic to perform the above-stated functions. Structurally, the logic may take any of a variety of forms such as a field programmable gate array (FPGA), a microprocessor, a digital signal processor, an application specific integrated circuit (ASIC) or any other specific use machine structure capable of carrying out the functions described herein. Logic may take any of a variety of forms, such as software and/or hardware. However, for illustrative purposes, tailored masking system 40 and logic included therein will be described herein as a specific use machine. As will be understood from the description, while logic is illustrated as including each of the above-stated functions, not all of the functions are necessary according to the teachings of the invention as recited in the appended claims.

In various embodiments, Processes P0-P4 can be iterated (repeated) periodically (e.g., according to schedule of x times per y period, and/or continuously) in order to mask one more portion of one or more turbomachine components 8. In some cases, one or more of processes P0-P4 can be repeated, for example, for a set of turbomachine components 8.

FIG. 4 shows another flow diagram illustrating a process according to various embodiments. It is understood that according to various embodiments, at least one of the processes shown and described herein as being associated with the tailored masking system 40 and related computer system 120 can be performed outside of (excluding) the computer system 120. For example, the flow diagram in FIG. 4 illustrates a series of processes that can be performed manually and/or with the aid of the detection system 14, stripping system 4, masking applicator 10, coating applicator 28 and/or selective masking system 40 shown and described herein. According to various embodiments, the process includes:

Process P11: Removing a previously applied coating from a turbomachine component;

Process P12: Obtaining data about at least one characteristic of at least one cooling aperture in the turbomachine component;

Process P13: Determining a masking plan for masking the at least one cooling aperture based upon the at least one characteristic;

Process P14: Applying a masking material to the turbomachine component according to the masking plan; and

Process P15: Applying a coating material to the turbomachine component after applying the masking material.

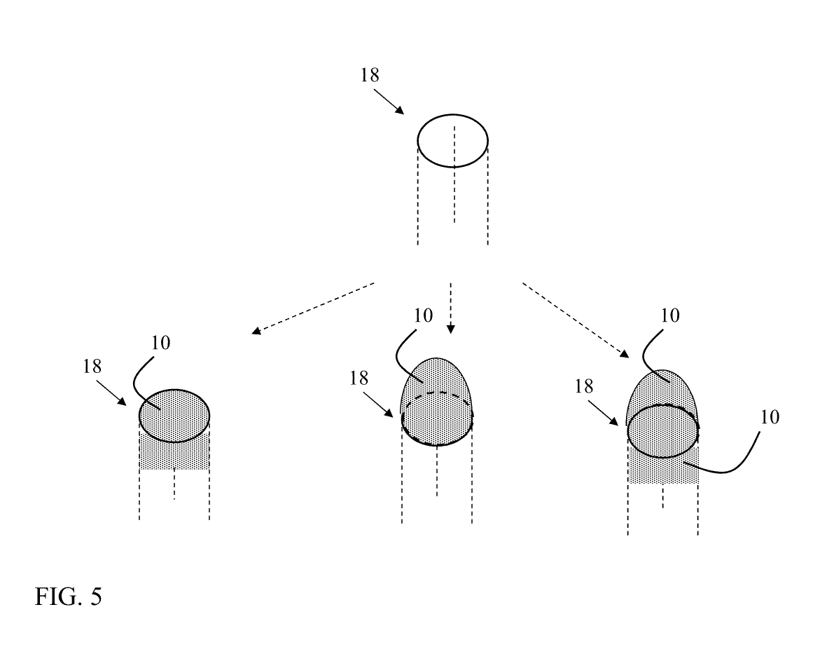

FIG. 5 shows schematic depictions of additional masking plans according to various embodiments. As shown, a turbomachine aperture 18 is masked using one of two masking techniques: (a) an in-hole masking technique where masking material 10 is deposited in the aperture 18 to substantially fill the aperture proximate its surface; and (b) an above-hole masking technique where masking material 10 is deposited over the aperture 18 to obstruct the aperture at the surface without substantially entering the aperture 18. In some cases, these techniques are combined in a third technique (c), a combined above-hole and in-hole masking technique where masking material 10 is deposited within the aperture 18 and over the aperture.

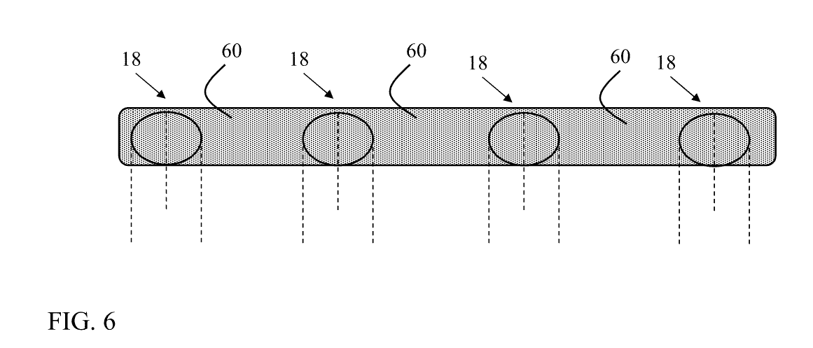

FIG. 6 shows a schematic depiction of an additional masking plan including forming a strip mask 60 over a plurality of apertures 18. This strip mask 60 can mask more than one aperture 18 at a time.

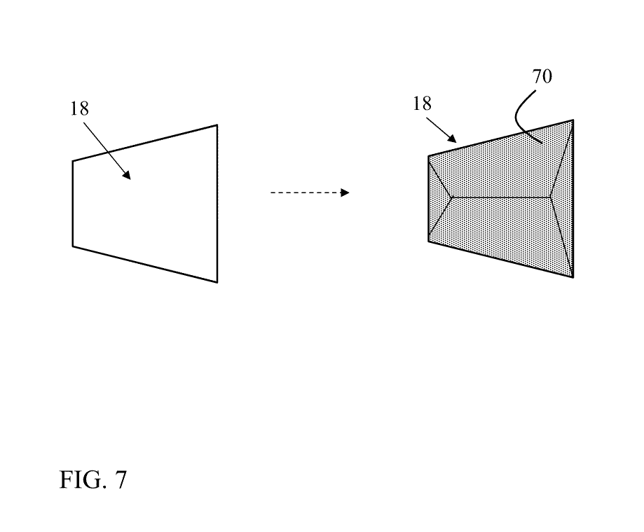

FIG. 7 shows a top schematic view of an alternative above-hole mask 70 that is formed over an aperture 18, and does not substantially fill the aperture 18 below its surface. In this case, the aperture 18 has a polygonal shape, and the above-hole mask 70 sits over the aperture 18.

It is understood that in the flow diagram shown and described herein, other processes may be performed while not being shown, and the order of processes can be rearranged according to various embodiments. Additionally, intermediate processes may be performed between one or more described processes. The flow of processes shown and described herein is not to be construed as limiting of the various embodiments.

In any case, the technical effect of the various embodiments of the invention, including, e.g., the tailored masking system 40, is to control application of a masking material 12 on a turbomachine component 8 in a tailored manner.

In various embodiments, components described as being “coupled” to one another can be joined along one or more interfaces. In some embodiments, these interfaces can include junctions between distinct components, and in other cases, these interfaces can include a solidly and/or integrally formed interconnection. That is, in some cases, components that are “coupled” to one another can be simultaneously formed to define a single continuous member. However, in other embodiments, these coupled components can be formed as separate members and be subsequently joined through known processes (e.g., fastening, ultrasonic welding, bonding).

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A system comprising:
a masking applicator; and
at least one computing device coupled with the masking applicator, the at least one computing device configured to provide instructions to the masking applicator to apply a masking material according to a masking plan for masking the at least one cooling aperture in the turbomachine component during a cooling aperture coating process, the masking plan based upon at least one characteristic of at least one cooling aperture in the turbomachine component, the masking plan including masking the at least one cooling aperture using a first mask type.

2. The system of claim 1, further comprising a detection system coupled with the at least one computing device, the detection system for detecting the data about the at least one characteristic of the at least one cooling aperture in the turbomachine component, wherein the data about the characteristic of the at least one cooling aperture includes detection data about a location of each of the at least one cooling aperture.

3. The system of claim 1, wherein the characteristic of the at least one cooling aperture includes at least one of a size of each of the at least one cooling aperture, a shape of each of the at least one cooling aperture, a type of each of the at least one cooling aperture or a location of each of the at least one cooling aperture.

4. The system of claim 1, wherein the data about the characteristic are obtained from a data model of the turbomachine component.

5. The system of claim 1, wherein the masking applicator includes a localized deposition apparatus.

6. The system of claim 1, wherein the at least one cooling aperture includes one of a round-shaped cooling aperture or an oblong-shaped cooling aperture.

7. The system of claim 1, wherein the at least one cooling aperture includes a plurality of cooling apertures, wherein the masking plan includes masking the at least one cooling aperture using a first mask type and masking at least one distinct cooling aperture using a second mask type, distinct from the first mask type.

8. The system of claim 7, wherein the first mask type protects against a first subsequent coating process, and wherein the second mask type protects against a second, distinct subsequent coating process.

9. The system of claim 1, further comprising a coating applicator coupled with the at least one computing device and configured to receive instructions from the at least one computing device to apply a metallic bondcoat and a thermal barrier coating (TBC) to the turbomachine component after the applying of the masking material according to the masking plan.

10. The system of claim 1, further comprising a stripping system for removing a previously applied coating from the turbomachine component prior to the applying of the masking material to the turbomachine component.

11. The system of claim 1, wherein the at least one cooling aperture includes a plurality of cooling apertures, and wherein the first mask type includes a continuous mask masking each of the plurality of cooling apertures.

12. The system of claim 1, wherein the at least one computing device is further configured to:
obtain data about the at least one characteristic of at least one cooling aperture in the turbomachine component prior to the providing of the instructions to the masking applicator; and
determine the masking plan for masking the at least one cooling aperture in the turbomachine component based upon the at least one characteristic of the at least one cooling aperture, prior to the providing of the instructions to the masking applicator.

13. The system of claim 1, wherein the masking of the at least one cooling aperture includes applying the masking material in the at least one cooling aperture, above the at least one cooling aperture, or both in and above the at least one cooling aperture.

14. A method comprising:
removing a previously applied coating from a turbomachine component;
obtaining data about at least one characteristic of at least one cooling aperture in the turbomachine component;
determining a masking plan for masking the at least one cooling aperture in the turbomachine component during a cooling aperture coating process based upon the at least one characteristic of the cooling aperture, the masking plan including masking the at least one cooling aperture using a first mask type;
applying a masking material to the turbomachine component according to the masking plan, after the removing of the previously applied coating; and
applying a coating material to the turbomachine component after the applying of the masking material according to the masking plan.

15. The method of claim 14, further comprising detecting the data about the at least one characteristic of the at least one cooling aperture in the turbomachine component, wherein the data about the characteristic of the at least one cooling aperture includes detection data about a location of the at least one cooling aperture.

16. The system of claim 14, wherein the characteristic of the at least one cooling aperture includes at least one of a size of each of the plurality of cooling apertures, a shape of each of the plurality of cooling apertures, a type of each of the plurality of cooling apertures or a location of each of the plurality of cooling apertures.

17. The system of claim 14, wherein the data about the characteristic are obtained from a data model of the turbomachine component.

18. The system of claim 14, wherein the at least one cooling aperture includes a plurality of cooling apertures, wherein the masking plan includes masking the at least one cooling aperture using a first mask type and masking at least one distinct cooling aperture using a second mask type, distinct from the first mask type, wherein the first mask type protects against a first subsequent coating process, and wherein the second mask type protects against a second, distinct subsequent coating process.

19. A computer program product comprising program code embodied in a computer readable storage medium, which when executed by at least one computing device, causes the at least one computing device to perform actions including:
obtaining data about at least one characteristic of at least one cooling aperture in a turbomachine component;
determining a masking plan for masking the at least one cooling aperture in the turbomachine component during a cooling aperture coating process based upon the at least one characteristic of the at least one cooling aperture, the masking plan including masking the at least one cooling aperture; and
providing instructions to a masking applicator to apply a masking material to the turbomachine component according to the masking plan.

20. The computer program product of claim 19, wherein the at least one cooling aperture includes a plurality of cooling apertures, wherein the masking plan includes masking the at least one cooling aperture using a first mask type and masking at least one distinct cooling aperture using a second mask type, distinct from the first mask type.
